(19) United States
(12) Patent Application Publication
(10) Pub. No.: US 2007/0070162 A1
(43) Pub. Date: Mar. 29, 2007

(54) Ink jet recording apparatus and recording method

(75) Inventor: Takeshi Yokoyama, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Medical & Graphic, Inc., Tokyo (JP)

(21) Appl. No.: 11/524,492

(22) Filed: Sep. 20, 2006

(30) Foreign Application Priority Data
Sep. 29, 2005 (JP) 2005-284814

(51) Int. Cl. B41J 2/01

(52) U.S. Cl. 347/102

(57) ABSTRACT

An object of the present invention is to provide an ink jet recording apparatus and a recording method that can prevent jetting defect, due to ink that adhered to recording head being cured, and conduct image recording with high resolution, by suppressing light that reaches the recording head to a required limit. The ink jet recording apparatus includes recording head to jet photo-curable ink on recording medium, ultraviolet ray irradiating device to irradiate ultraviolet ray to the ink jetted from the recording head, width detecting sensor to detect recording region, and control part to control the ultraviolet ray irradiating device to suppress amount of light that is irradiated from the ultraviolet ray irradiating device and rounds into the recording head side, to an extent so that the ink is not cured, in a region other than the recording region detected by the width detecting sensor.

### BACKGROUND OF THE INVENTION

1. Field of the Invention

The present invention relates to an ink jet recording apparatus and recording method, particularly to an ink jet recording apparatus and recording method to record an image by using photo-curable ink that is cured by irradiating light.

2Description of Related Art

In general, as a means that can conduct printing on various kinds of recording mediums, ink jet recording apparatus that conducts image recording by ink jet method has been known. Ink jet recording apparatus is an apparatus in which ink is jetted from a nozzle provided on a surface of a recording head that face the recording medium, the ink arrives on the recording medium, and the ink is fixed, thus recording an image on the recording medium.

Recently, in addition, as for an ink jet recording apparatus that can manage various kinds of recording medium, ink jet recording apparatus that uses photo-curable ink has been known. Here, by using a photo-curable ink containing photo initiator with a predetermined sensitivity towards light, and irradiating light to ink that arrived on the recording medium, ink is cured to be fixed on the recording medium. Concerning such ink jet recording apparatus using photo-curable ink, since ink is cured instantly by irradiating light after the ink arrived on the recording medium, penetration and blurring of the ink to the recording medium is scarce. Therefore, image recording can be also conducted to recording medium that has no ink absorbing property such as plastic, metal, and the like, as well as standard paper.

However, in such ink jet recording apparatus, light irradiated from light irradiating device is reflected by the recording medium and platen that supports the recording medium, and reaches the recording head. Therefore, it may result in defect in image recording, such as ink that adheres or accumulates at the nozzle surface of the recording head is cured, thus jetting of ink from the nozzle is distorted, and causes lack in nozzle due to clogging of the nozzle.

Here, the amount of light that reaches the nozzle surface of the recording head by being reflected by the recording medium or the platen increases in accordance with the increase in distance between light source to irradiate light and the recording medium or the platen. Therefore, conventionally, a recording apparatus in which amount of reflected light that reaches the recording head is suppressed by defining the distance between the light source to irradiate light and the recording medium or the platen, has been proposed. (For example, refer to Japanese Patent Application Laid-Open No. 2004-167917.)

In addition, a recording apparatus in which light irradiated from the light irradiating device is prevented from entering the recording head by being reflected by the recording medium or the platen, by providing a reflecting plate to reflect light so that the reflecting plate comes close to the lower side of the irradiation outlet of the light irradiating device, has been proposed. (For example, refer to Japanese Patent Application Laid-Open No. 2004-338264.)

Further, a recording apparatus in which amount of light irradiated from the light irradiating device is adjusted so as to obtain desired image has been proposed. As a means to decrease the amount of reflected light, providing a shutter to shield light from the irradiation outlet of the light irradiating device is disclosed. (For example, refer to Japanese Patent Application Laid-Open No. 2004-1327.) Light irradiated from the light irradiating device can also be prevented from entering the recording head, due to reflection at the recording medium, by such shutter mechanism.

However, since one of the features of the ink jet recording apparatus is that it can conduct image recording to various kinds of recording mediums, there are cases where image recording is conducted to a recording medium with thickness. In a case where distance between the recording medium or the platen, and the light irradiating device is set in view of the thickness of the recording medium, when the width of the recording medium is narrow for example, a portion where there is no recording medium at a position facing the light irradiating device occurs. Thus, there was a problem that since the distance between the light irradiating device and the platen becomes large at this portion, amount of light that reaches the recording head by being reflected by the platen increases.

In addition, in a case where the width of the image to be recorded is narrower than that of the recording medium, and light is irradiated from the light irradiating device to a larger region than the width in which image recording is conducted, light irradiation is conducted to region that does not need light irradiation concerning original purpose of the image recording. Therefore, there was a problem that in a case where recording medium with high degree of reflection is used, the light reflected at the recording medium reaches the recording head, cures the ink adhered to the nozzle of the recording head, and results in jetting defect such as distortion of ink jetting and lack in nozzle.

### SUMMARY OF THE INVENTION

The present invention has been made in order to solve the above mentioned problems. An object of the present invention is to provide an ink jet recording apparatus and recording method that can conduct image recording with high resolution, by suppressing the irradiated light to required limit and preventing jetting defect due to the ink adhered to the recording head being cured by reflected light.

In order to achieve the above mentioned object, according to a first aspect of the present invention, this ink jet recording apparatus comprises:

a recording head to jet a photo-curable ink, that is cured by irradiating light, on a recording medium;

a light irradiating device to irradiate light to a jetted ink jetted from the recording head;

a recording region detecting section to detect a recording region; and

a control part to control light quantity irradiated from the light irradiating device so that amount of light which is irradiated from the light irradiating device and rounds into the recording head side is suppressed to an extent so that the photo-curable ink is not cured, in a region other than the recording region detected by the recording region detecting section.

As mentioned above, according to the first aspect of the present invention, in a case where the photo-curable ink is jetted from the recording head on the recording medium, and light is irradiated from the light irradiating device to the ink jetted from the recording head in order to record, the light irradiating device is controlled by the control part so as to detect the recording region by the recording region detecting section, and control so that amount of light which is irradiated from the light irradiating device and rounds into the recording head side is suppressed to an extent so that the ink is not cured, in the region other than the recording region.

Therefore, since amount of light which is irradiated from the light irradiating device and rounds into the recording head side is suppressed to an extent so that the ink is not cured in the predetermined region other than the recording region, amount of light that is irradiated to the recording medium and the like can be suppressed to required limit and thus suppress light that enters the recording head. Therefore, jetting defect and the like due to the ink adhered to the recording head being cured by the reflected light can be prevented, and image recording with high resolution can be achieved.

Preferably, the recording region detected by the recording region detecting section is a region in which the recording medium is positioned.

The amount of light that reaches the nozzle surface of the recording head by being reflected by the recording medium or the platen increases in accordance with the increase in distance between light source to irradiate light and the recording medium or the platen. As mentioned above, by defining the region in which the recording medium is positioned as the recording region detected by the recording region detecting section, amount of light which is irradiated from the light irradiating device and rounds into the recording head side is suppressed to an extent so that the ink is not cured in a region other than the region in which the recording medium is positioned. Therefore, for example, even in a case where distance between the light source and the recording medium or the platen is set large in order to adapt to a thick recording medium, amount of light that reaches the nozzle surface of the recording head is suppressed by decreasing amount of light from the light source in the portion without the recording medium. Thus, jetting defect and the like due to the ink adhered to the nozzle surface and the like being cured by the reflected light can be prevented.

Preferably, the recording region detected by the recording region detecting section is a recording width of an image that is to be recorded on the recording medium.

By defining the recording width of the image that is to be recorded on the recording medium as the recording region detected by the recording region detecting section, amount of light which is irradiated from the light irradiating device and rounds into the recording head side is suppressed to an extent so that the ink is not cured in a region other than the recording width of the image that is to be recorded on the recording medium. Therefore, amount of light that is irradiated can be suppressed to required limit, and the light that enters the recording head can be decreased. As a result, jetting defect and the like due to the ink adhered to the recording head being cured by the reflected light can be prevented, and image recording with-high resolution can be achieved.

Further, it is preferable that the light irradiating device further comprises a light shielding mechanism that is capable to shield light irradiated by the light irradiating device entirely or partially,

wherein the control part controls the light shielding mechanism so that the amount of light which is irradiated from the light irradiating device and rounds into the recording head side is suppressed to an extent so that the photo-curable ink is not cured, in a region other than the recording region detected by the recording region detecting section.

As described, since the light shielding mechanism suppresses the amount of light which is irradiated from the light irradiating device and rounds into the recording head side to an extent so that ink is not cured, in a region other than the recording region, it is not needed to turn off the light irradiating device to suppress the amount of light. Therefore, excessive light can be suppressed efficiently in a case where a light source that requires long time to start up when it is turned on after being turned off is used.

Preferably, ink light irradiating device further comprises a light guiding mechanism that is capable to guide light irradiated by the light irradiating device entirely or partially;

wherein the control part controls the light guiding mechanism so that amount of light which is irradiated from the light irradiating device and rounds into the recording head side is suppressed to an extent so that the photo-curable ink is not cured, in a region other than the recording region detected by the recording region detecting section.

As described, since the light guiding mechanism suppresses the amount of light which is irradiated from the light irradiating device and rounds into the recording head side to and extent so that the ink is not cured, in a region other than the recording region, it is not needed to turn off the light irradiating device to suppress the amount of light. Therefore, excessive light can be suppressed efficiently in a case where a light source that requires long time to start up when it is turned on after being turned off is used.

Preferably, the control part controls the light irradiating device so as to turn off the light irradiating device in a region other than the recording region detected by the recording region detecting section.

As described, since the light irradiating device is turned off in the region other than the recording region, excessive light can be suppressed as well as power consumption can be suppressed.

Preferably, the in jet recording apparatus further comprise a recording medium supporting member to support the recording medium,

wherein the control part determines whether or not to conduct control so that the amount of light which is irradiated from the light irradiating device and rounds into the recording head side is suppressed to an extent so that the photo-curable ink is not cured, according to distance between a surface of the recording head that face the recording medium and the recording medium supporting member.

As described, it is determined whether or not to conduct control so that amount of light which is irradiated from the light irradiating device and rounds into the recording head side is suppressed to an extent so that the ink is not cured, according to the distance between the surface of the recording head that face the recording medium and the recording medium supporting member. Therefore, efficient control such as suppressing the amount of light only in a case where the distance between the surface of the recording head that face the recording medium and the recording medium supporting member is large, and the amount of light that reaches the nozzle surface of the recording head by being reflected by the recording medium or the platen is large, can be achieved.

Preferably, the control part determines whether or not to conduct control so that the amount of light which is irradiated from the light irradiating device and rounds into the recording head side is suppressed to an extent so that the photo-curable ink is not cured, according to thickness of the recording medium.

As described, it is determined whether or not to conduct control so that amount of light which is irradiated from the light irradiating device and rounds into the recording head side is suppressed to an extent so that the ink is not cured, according to the thickness of the recording medium. Therefore, efficient control such as suppressing the amount of light only in a case where the distance between the surface of the recording head that face the recording medium and the recording medium supporting member is large, and the amount of light that reaches the nozzle surface of the recording head by being reflected by the recording medium or the platen is large, can be achieved.

Preferably, the recording head is a serial print type that jets the photo-curable ink on the recording medium within moving in a direction that is orthogonal to a feeding direction of the recording medium.

As described, even in a case where image recording is conducted using the ink jet recording apparatus of serial print type, jetting defect and the like due to the ink adhered to the recording head being cured by the reflected light can be prevented, and image recording with high resolution can be achieved.

Preferably, the light irradiating device comprises an upstream light irradiating device and a downstream light irradiating device that are arranged at upstream side and downstream side regarding a moving direction of the recording head respectively; and

the control part controls the amount of light which is irradiated from the light irradiating device and rounds into the recording head side, independently with the upstream light irradiating device and the downstream light irradiating device.

In a case where recording is conducted by the serial print type, regarding ink curing, light irradiated only from the light irradiating device that is arranged at the upstream side regarding the feeding direction of the recording head is sufficient. According to the structure afore-mentioned, amount of light which is irradiated from the light irradiating device and rounds into the recording head side is controlled independently, concerning a light irradiating device arranged at upstream side and a light irradiating device arranged at down stream side. Therefore, excessive irradiation of light can be prevented and ink that adhere to the recording head or the like is prevented from being cured by the reflected light.

Preferably, the recording head moves reciprocally;

the control part conducts control so that the photo-curable ink is jetted from the recording head only when the recording head moves in one of either directions; and

the control part conducts control-according to movement of the recording head, so that the amount of light which is irradiated from the light irradiating device and rounds into the recording head side is suppressed.

As described, it is controlled so that the light is irradiated only when the recording head moves in the direction in which ink is jetted, concerning a case where ink is jetted only when the recording head is moving in one of the directions, what is called one-directional printing. Therefore, excessive light can be prevented and ink that adhere to the recording head or the like is prevented from being cured by the reflected light.

Preferably, the photo-curable ink is an ultraviolet ray curing ink that is cured by irradiating ultraviolet ray, and at least part of the light irradiated from the light irradiating device is ultraviolet ray.

As described, a predetermined image is formed through curing and firming the ink by irradiating ultraviolet ray to the ink that arrived the recording medium, after the ink is jetted. Therefore, image recording with high resolution can be achieved not only for a recording medium with high ink absorbability such as paper, but also for a recording medium with low ink absorbability or a recording medium with no ink absorbability.

Preferably, the photo-curable ink is a cationic polymerization type ink including a cationic polymerizing compound.

In contrast to radical polymerization type ink, polymerization reaction of the cationic polymerization ink is less inhibited by the oxygen contained in the atmosphere. Therefore, it can be cured in short time, and light source with high energy output is not needed for curing. As a result, a large light source is not needed to be provided, and the apparatus can be downsized and lightened, as well as cost can be suppressed. Further, the cationic polymerization ink has a property in that it accumulates light, and excessive light can be suppressed even in a case where such ink is used. Therefore, ink that adhered to the recording head or the like can be prevented from being cured by the reflected light.

According to a second aspect of the present invention, the recording method comprises:

a jetting step to jet a photo-curable ink, that is cured by irradiating light, from a recording head to a recording medium;

a light irradiating step to irradiate light from a light irradiating device to a jetted ink jetted from the recording head;

a detecting step to detect a recording region; and

a suppressing step to suppress amount of light which is irradiated from the light irradiating device and rounds into the recording head side to an extent so that the photo-curable ink is not cured, in a region other than the recording region, according to detection result.

Therefore, according to the second aspect of the present invention, in a case where recording is conducted by jetting a photo-curable ink from the recording head to the recording medium, and then irradiating light from the light irradiating device to the ink that was jetted from the recording head, the recording region is detected, and the light irradiating device is controlled by the control part so as to suppress amount of light that is irradiated from the light irradiating device and rounds into the recording head side to an extent so that it does not cure ink, in a region other than the recording region.

Therefore, amount of light that is irradiated from the light irradiating device and rounds into the recording head side is suppressed to an extent so that it does not cure ink, in a predetermined region other than the recording region. As a result, amount of light that is irradiated to the recording medium and the like can be suppressed to a required limit, and light that enters the recording head can be suppressed. Therefore, jetting defect and the like due to the ink adhered to the recording head being cured by the reflected light can be prevented, and image recording with high resolution can be achieved.

### BRIEF DESCRIPTION OF THE DRAWINGS

The present invention will become more fully understood from the detailed description given hereinbelow and the accompanying drawing which are given by way of illustration only, and thus are not intended as a definition of the limits of the present invention, and wherein;

FIG. 1 is a perspective side view showing a structure of an ink jet recording apparatus of the first embodiment according to the present invention;

FIG. 2 is a perspective side view showing a carriage and an ultraviolet ray irradiating device provided to the ink jet recording apparatus of FIG. 1;

FIG. 3 is a cross-sectional side view of the ultraviolet ray irradiating device shown in FIG. 2;

FIG. 4 is a perspective side view of a shutter mechanism provided to the ultraviolet ray irradiating device shown in FIG. 2;

FIG. 5 is a side view of the shutter mechanism shown in FIG. 4;

FIG. 6 is a cross-sectional side view of a shutter part of the shutter mechanism shown in FIG. 4;

FIG. 7 is a block diagram of control structure concerning the first embodiment of the ink jet recording apparatus according to the present invention;

FIG. 8A is a view to explain a way of reflection in a case where light irradiated from the ultraviolet ray irradiating device is reflected at a recording medium;

FIG. 8B is a view to explain a way of reflection in a case where light irradiated from the ultraviolet ray irradiating device is reflected at a platen;

FIG. 9 is a cross-sectional side view showing a frame format of a modified shutter mechanism provided to the ultraviolet ray irradiating device shown in FIG. 2;

FIG. 10 is a side view of a light guiding mechanism of the second embodiment concerning the ink jet recording apparatus according to the present invention;

FIG. 11 is a cross-sectional side view of a light guiding part of the light guiding mechanism shown in FIG. 10; and

FIG. 12 is a perspective side view of the ultraviolet ray irradiating device of the fourth embodiment concerning the ink jet recording apparatus according to the present invention, seen from beneath.

### PREFERRED EMBODIMENTS OF THE INVENTION

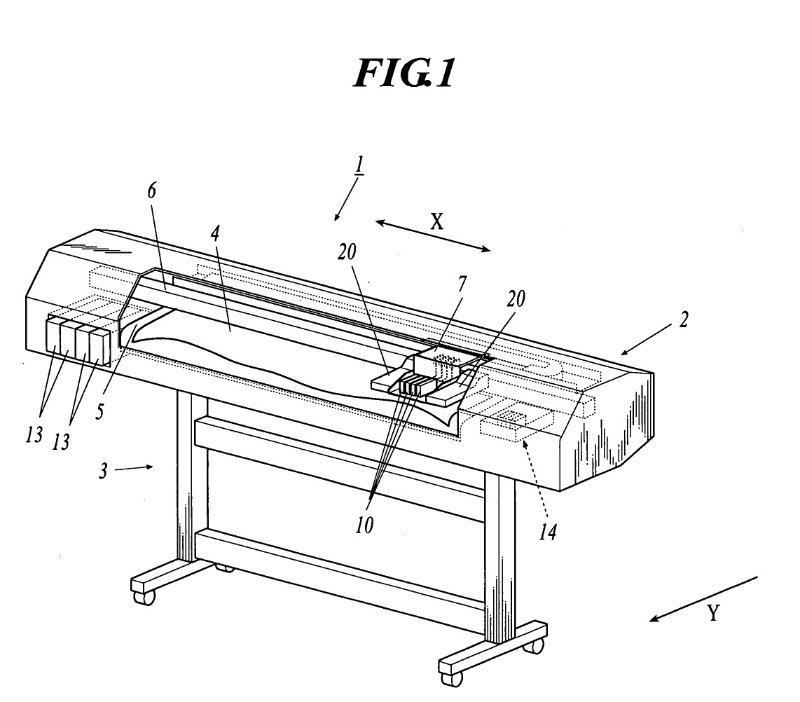

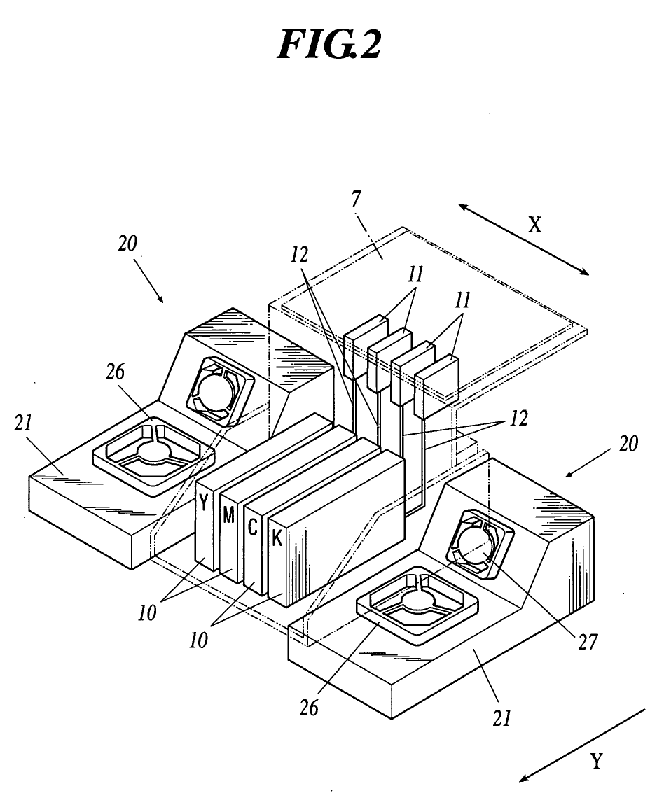

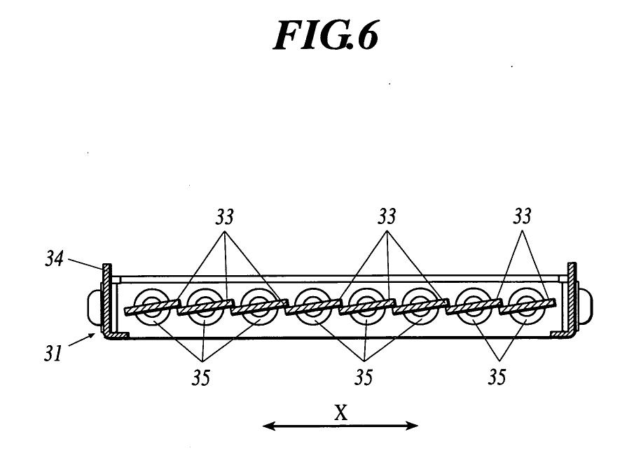

Hereinafter, the first embodiment according to the present invention will be explained with reference to FIGS. 1 to 8.

First of all, as shown in FIG. 1, concerning the present embodiment, ink jet recording apparatus 1 is a serial print type, and is provided with a printer body 2 and a supporting stand 3 to support the printer body 2 from beneath. In the center portion of the printer body 2, a platen 5 as a recording medium supporting member to support a recording medium from a non-recording surface is arranged so as to lie in the longitudinal direction of the printer body 2.

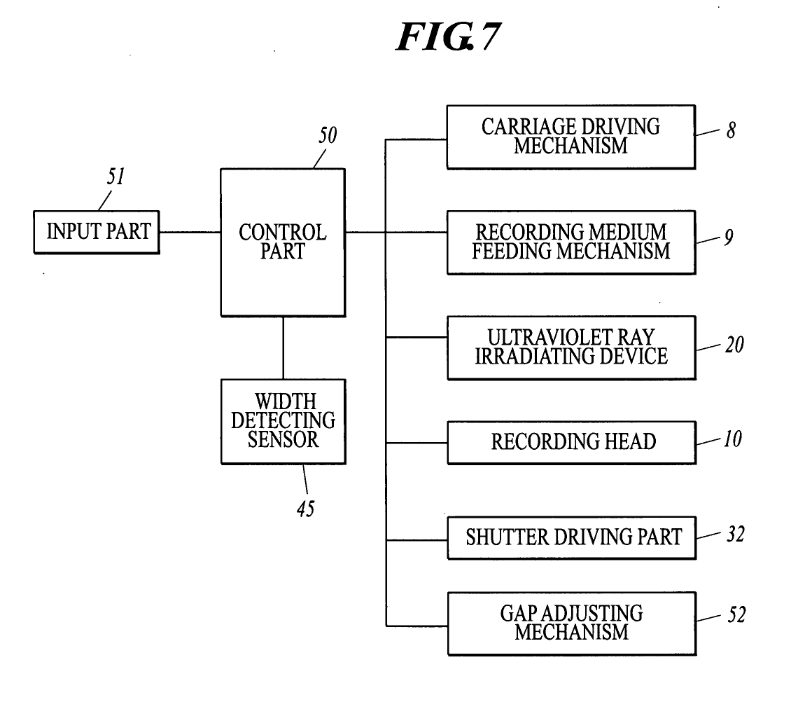

At the upper side of the platen 5, a guide rail 6 formed in a rod shape is provided so as to lie in the longitudinal direction of the printer body 2. Carriage 7 is supported by the guide rail 6, and the carriage 7 reciprocally moves along the guide rail 6 in a main scanning direction X by a carriage driving mechanism 8 (refer to FIG. 7).

In addition, to the printer body 2, a recording medium feeding mechanism 9 (refer to FIG. 7) to feed the recording medium 4 in a sub-scanning direction Y, which is perpendicular to the main scanning direction X, is provided. The recording medium feeding mechanism 9 is, for example, structured with a feeding motor, feeding roller, and the like (not shown), and feeds the recording medium 4 along the platen 5 from the upstream to the downstream in the sub-scanning direction Y by rotating the feeding roller by driving the feeding motor. When conducting image recording, the recording medium feeding mechanism 9 intermittently feeds the recording medium 4 in the sub-scanning direction Y, by repeatedly performing the feeding and stopping of the recording medium 4, in synchronization with the movement of the carriage 7.

Four recording heads 10 corresponding to each of the colors (for example, yellow (Y), magenta (M), cyan (C), and black (K)), used in the ink jet recording apparatus 1 of the present invention, are arranged to the carriage 7. Each of the recording head 10 is formed in a substantially rectangular solid in terms of outer appearance, and are arranged so that their longitudinal direction is parallel with each other. The surface of the recording head 10 that face the recording medium 4 is a nozzle surface in which a plurality of nozzles (not shown) are formed in a row along the longitudinal direction of the recording head 10.

Here, the ink used by the ink jet recording apparatus is not limited to the ones mentioned as an example, and ink of various kinds of colors such as light yellow (LY), light magenta (LM), light cyan (LC), white ink, transparent ink, and the like, can be used for example. In such case, a recording head corresponding to each color is provided in the carriage. Further, the number of each recording head 10 is not limited to the one mentioned as an example, and further larger number of recording heads may be provided in the carriage. In addition, it may have a structure in which more than two head units, that bind four recording heads 10 that correspond to each color of ink used, are provided in the carriage. In such case, each head unit is provided in the carriage so that they are displaced in the sub-scanning direction Y.

To the carriage 7, intermediate tank 11 to store ink and supply ink to the recording head 10 is provided in the number corresponding to the number of each recording head 10. Each of the recording head 10 is connected to the intermediate tank 11 through an ink supply tube 12. Here, the intermediate tank 11 is connected to an ink tank 13, which is provided to an end of the moving region of the carriage 7 and external of the platen 5, through an ink supplying path (not shown). Thus, ink can be supplied to the recording head 10 from the ink tank 13 through the intermediate ink tank 11 as needed.

Further, to the carriage 7, a gap adjusting mechanism 52 (refer to FIG. 7) to move up and down the carriage 7 is provided. The ink jet recording apparatus 1 is structured so as to be capable of adjusting distance (gap) between the recording head 10 arranged in the carriage 7 and the platen 5, by moving the carriage 7 up and down according to the thickness of the recording medium 4, with the gap adjusting mechanism 52. Here, the gap adjusting mechanism 52 to adjust distance between the recording head 10 arranged in the carriage 7 and the platen 5 is not limited to a case where it is provided to the carriage 7. For example, the gap adjusting mechanism 52 may be provided to the platen 5, and the platen 5 may be moved up and down according to the thickness of the recording medium 4.

To the both sides of the carriage 7, ultraviolet ray irradiating device 20 as light irradiating device are each provided so as to contact the side of the carriage 7. The ultraviolet irradiating device 20 is provided with a cover member 21 which is formed in a box-shape and has an opening at one end surface, and the ultraviolet ray irradiating device 20 is arranged so that the opening of the cover member 21 faces the recording surface of recording medium 4. In addition, a low pressure mercury lamp 22 as an ultraviolet ray source to irradiate ultraviolet ray for curing and firming the ultraviolet ray curing ink that arrived on the recording medium 4 is provided inside the cover member 21.

Here, in the present embodiment, a case where the low pressure mercury lamp 22 is used as the ultraviolet ray source will be described, however, the type of light source that can be applied to the present invention is not limited in particular. For example, as the ultraviolet ray source, a high pressure mercury lamp, a metal halide lamp, a laser diode, a cold cathode tube, an excimer lamp, a light emitting diode (LED), and the like can be used. Here, the position where the ultraviolet ray irradiating device 20 is provided and its shape is not limited to the given example.

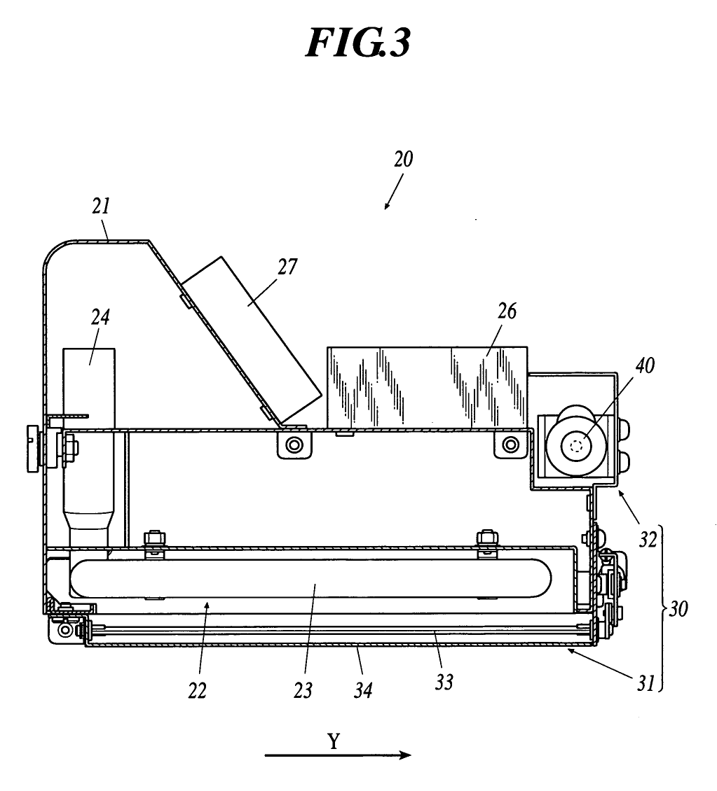

The low pressure mercury lamp 22 is, as shown in FIG. 3, structured with and arc tube 23 with a length longer than that of the recording head 10 in the longitudinal direction, provided along the sub-scanning direction Y, and a cylinder cap member 24 attached to both ends of the arc tube 23. The arc tube 23 emits light by conducting electricity to the cap member 24. Here, the shape of the arc tube 23 of the low pressure mercury lamp 22 is not limited in particular, and one with a structure provided with one or a plurality of bending portion in the mid of the arc tube 23 to bend the arc tube 23 to have a predetermined length, may be used.

To a position where it is an external side of the cover member 21 and corresponds to the arc tube 23, an arc tube cooling fan 26 to prevent increase in temperature of the arc tube 23 of the low pressure mercury lamp 22 is provided. In addition, to a position where it is an external side of the cover member 21 and corresponds to the cap member 24, a cap member cooling fan 27 to cool the cap member 24 is provided.

To the cover member 21, a shutter mechanism 30 as a light shielding mechanism to shield light from the low pressure mercury lamp 22 is provided. The shutter mechanism 30 is structured with a shutter part 31 that can shield light irradiated from the low pressure mercury lamp 22 by covering the opening of the cover member 21, and a shutter driving part 32 to drive the shutter part 31.

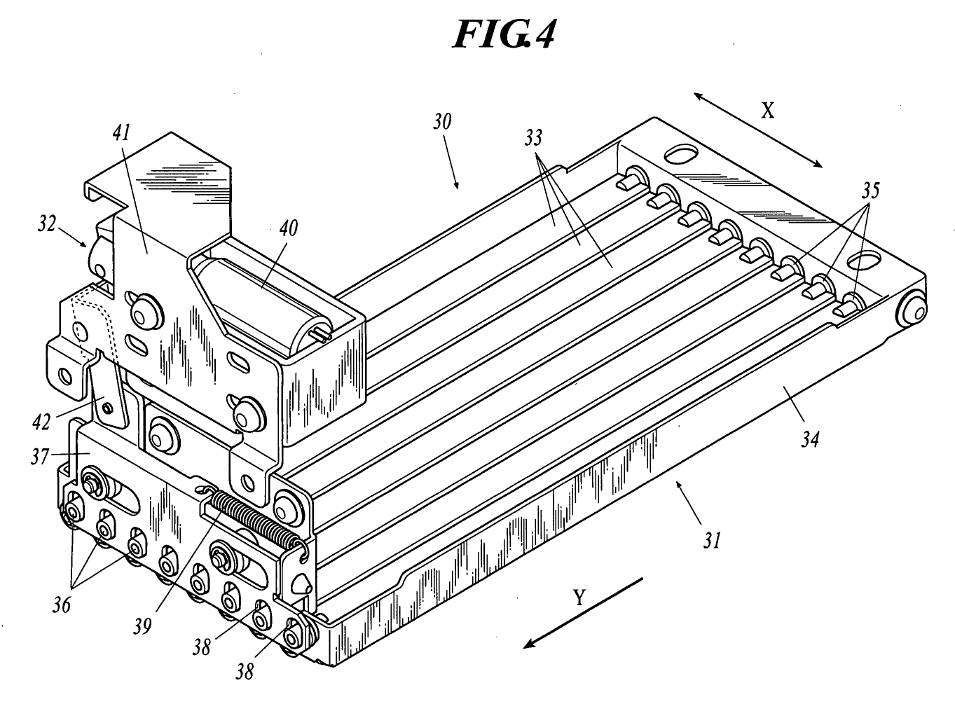

As shown in FIGS. 3 and 4, to the shutter part 31, a plurality of shutter plates 33 that have a substantially the same length as that of the opening of the cover member 21 in the longitudinal direction, and a shutter plate supporting member 34 to support the shutter plates 33, are provided. The shutter plate supporting member 34 is a frame body that is formed with substantially the same area as that of the opening of the cover member 21, and is attached to the opening of the cover member 21 with a screw or the like (not shown).

To the both end sides of the shutter plate supporting member 34 in the sub-scanning direction Y, a supporting member 35 to support the shutter plate 33 is provided in a number corresponding to the number of shutter plate 33. The shutter plate 33 is supported by the shutter plate supporting member 34 rotatably to the main scanning direction X by being supported by the supporting member 35 at both sides. The shutter plate 33 is formed with a width so that the edge of adjacent shutter plate 33 slightly overlaps with each other when the shutter mechanism 30 is closed, thus light from the low pressure mercury lamp 22 can be shielded completely.

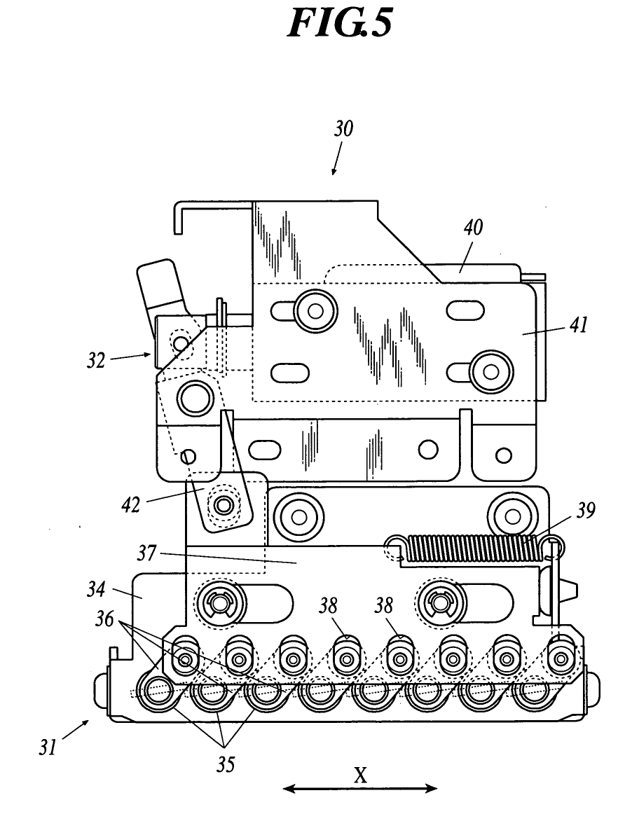

As shown in FIG. 5, to the supporting member 35 provided to one end side of the shutter plate supporting member 34, an arm-shaped member 36 that can each oscillate is attached, and the supporting member 35 rotate in the main scanning direction X according to the oscillation of the arm-shaped member 36. An end of the arm-shaped member 36 are each seized to a seizing pore 38 formed to an oscillating member 37 that oscillates according to the operation of the shutter driving part 32. In the present embodiment, when the oscillating member 37 oscillates from the right side to the left side in the main scanning direction X, the supporting member 35 rotates in a direction so that the shutter plate 33 is opened. In contrast, when the oscillating member 37 oscillates from the left side to the right side in the main scanning direction X, the supporting member 35 rotates in a direction so that the shutter plate 33 is closed. In addition, the oscillating member 37 is seized to the shutter plate supporting member 34 by a spring 39, thus the oscillating member 37 is powered in a direction so that the shutter plate 33 is closed.

The shutter driving part 32 is, for ekample, provided with a solenoid 40 that conducts reciprocal movement along the main scanning direction X by application of current, and a driving part supporting member 41 to support the solenoid 40. To the solenoid 40, a transmission arm 42 that has its one end seized to the oscillating member 37 is attached, and the reciprocal movement of the solenoid 40 is transmitted to the oscillating member 37 through the transmission arm 42.

In addition, a plurality of width detecting sensors 45 as a recording region detecting section are provided on the platen 5 to detect a position of the recording medium 4 by detecting a position of both ends of the recording medium 4 in the main scanning direction X (refer to FIG. 7). The width detecting sensor 45 is an optical sensor that is provided with a light emitting element such as Light Emitting Diode (LED) and the like, and a light receiving element such as Charge Coupled Device (CCD) and the like (not shown). When the recording medium 4 is positioned at a position where the width detecting sensor 45 is provided, light from the light emitting element is shielded by the recording medium 4, thus the light receiving element does not detect light. On the contrary, when the recording medium 4 is not positioned at a position where the width detecting sensor 45 is provided, light from the light emitting element is not shielded and is detected by the light receiving element. In this way, the width detecting sensor 45 detects the position of the end of the recording medium 4 according to whether light from the light emitting element is detected without being shielded or not. The width detecting sensor 45 outputs detection result as an electronic signal to a control part 50 described later.

In addition, to a position where it is the other end of the moving region of the carriage 7, and is opposed to the ink tank 13 with the platen 5 in between, a maintenance unit 14 to conduct maintenance of the recording head 10 is provided.

The ink used in the present embodiment is a photo-curable ink that can be cured by irradiating ultraviolet ray as light, and contains at least a polymerizing compound (including the known polymerizing compound), a photochemical initiator, and a color material as main components. The photo-curable ink can be classified into a radical polymerization type ink including a radical polymerizing compound as the polymerizing compound, and a cationic polymerization type ink including a cationic polymerizing compound. However, in the present embodiment, the cationic polymerization type ink that cures with ultraviolet ray, which shows difference in curing reaction due to moisture and temperature, is particularly used. The cationic polymerization type ink used in the present embodiment is a mixture including at least a cationic polymerizing compound such as an oxetane compound, an epoxy compound, a vinyl ether compound or the like, a photochemical cationic initiator, and a color material.

Next, as for the recording medium 4 used in the present embodiment, various kinds of papers applied to an ordinary ink jet recording apparatus such as a standard paper, a recycled paper, a glossy paper, and the like; and recording medium made of materials such as various kinds of cloth, various kinds of non-woven fabrics, resin, metal, glass, and the like can be applied. In addition, concerning the shape of the recording medium 4, a roll shape, a cut sheet shape, a plate shape, and the like can be applied.

Next, with reference to FIG. 7, controlling structure of the ink jet recording apparatus 1 according to the present embodiment is described.

To the ink jet recording apparatus 1, a control part 50 to control each part is provided. This control part 50 is provided with, for example, a Central Processing Unit (CPU), a Read Only Memory (ROM) to store various kinds of control programs and the like, and a Random Access Memory (RAM) to temporary store image data and the like (all of them not shown). The control part 50 spreads the control program recorded in the ROM in a working region of the RAM and executes the control program by the CPU.

In addition, the ink jet recording apparatus 1 has an input part 51 to input type of recording medium 4, image recording conditions, and the like. The information inputted from the input part 51 is sent to the control part 50. The input part 51 is, for example, a keyboard or an operation panel, and a user can set a type, thickness, size, and the like of the recording medium 4 used for the image recording, by operating the input part 51.

In addition, to the control part 50, image data relating to recorded image is sent from an external device such as a personal computer (not shown), and the sent image data is stored in the memory part not shown. The control part 50 controls the recording medium feeding mechanism 9 so as to intermittently feed the recording medium 4 in the sub-scanning direction Y. At the same time, the control part 50 operates the recording head 10 according to image data and information or the like inputted from the input part 51, while controlling the carriage driving mechanism 8 to reciprocally move the carriage 7 in the main scanning direction X. Thus, appropriate amount of ink is jetted from the recording head 10. Further, the control part 50 operates the ultraviolet ray irradiating device 20 to irradiate ultraviolet ray to the ink jetted on the recording medium 4, in order to cure and fix the ink.

To the control part 50, detection result is sent from the width detecting sensor 45. The control part 50 determines a width, in which the width detecting sensor 45 detected that the recording medium 4 is positioned, as the recording region. In a region other than the recording region, the shutter mechanism 30 of the ultraviolet ray irradiating device 20 is closed, so that the ultraviolet ray irradiated from the low pressure mercury lamp 22 is shielded.

Here, it is known that the ultraviolet ray curing ink of cationic polymerization type is cured when ultraviolet ray with light quantity of not less than approximately 20 mj/cm² per one hour is irradiated, and is cured gradually from the edge of the ink when ultraviolet ray with light quantity of not less than approximately 5 mj/cm² per one hour is irradiated. Concerning that maintenance of nozzle surface of the recording head 10 is generally conducted once per one hour, it is preferable that amount of ultraviolet ray which rounds into the nozzle surface of the recording head 10 is kept within 1 mj/cm² per one hour or less, in order to prevent jetting defect due to curing of the ink that adheres to the nozzle surface of the recording head 10 or the like.

From this point of view, when the ultraviolet ray is shielded by closing the shutter mechanism 30 of the ultraviolet ray irradiating device 20 in the region other than the recording region, light quantity of ultraviolet ray that is irradiated from the ultraviolet ray irradiating device 20 and is reflected at the platen 5 or the like can be suppressed. Therefore, amount of ultraviolet ray that rounds into the nozzle surface of the recording head 10 can be suppressed to within 1 mj/cm² per one hour or less, which is an extent that curing of the ink adhered to the nozzle surface of the recording head 10 or the like does not occur.

Timing in which the control part 50 conducts opening and closing of the shutter mechanism 30 of the ultraviolet ray irradiating device 20 is as described hereinafter for example.

That is, the control part 50 opens the shutter mechanism 30 of the ultraviolet ray irradiating device 20 when any one of the ultraviolet ray irradiating device 20 partially overlaps with the recording region. When any one of the ultraviolet ray irradiating device 20 entirely deviates from the recording region, the control part 50 closes the shutter mechanism 30 of the ultraviolet ray irradiating device 20.

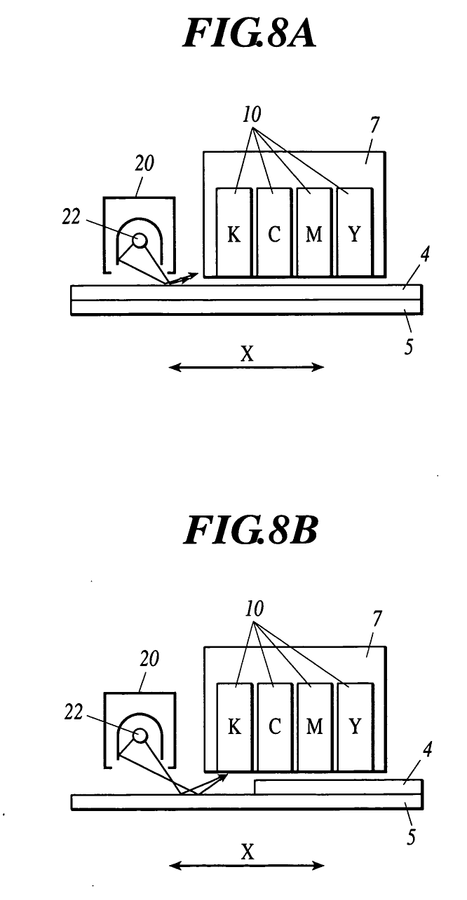

In particular, as shown in FIG. 8 for example, when image recording is conducted within moving the carriage 7 from right to left in the main scanning direction X shown in FIG. 8, ultraviolet ray irradiating device 20 which is positioned at the downstream side of the moving direction of the carriage 7 passes over the recording region in which the recording medium 4 is positioned, before the carriage 7 passes over upper side of the recording medium 4. The light irradiated from ultraviolet ray irradiating device 20 is reflected at the recording medium 4 when the recording medium 4 exists (refer to FIG. 8A). In this case, since the distance between the ultraviolet ray irradiating device 20 and the recording medium 4 is narrow, reflected light is not diffused widely, thus the reflected light does not reach the nozzle surface of the recording head 10. On the other hand, when the ultraviolet ray irradiating device 20 is positioned in a region where the recording medium 4 does not exist (refer to FIG. 8B), the light irradiated from the ultraviolet ray irradiating device 20 is reflected at the platen 5.

In this case, since the distance (gap) between the platen 5 and the recording head 10 is set large regarding the thickness of the recording medium 4, the distance between the ultraviolet ray irradiating device 20 provided at both sides of the carriage 7 arranged with the recording head 10, and the platen 5 is also large. Therefore, the light reflected at the platen 5 diffuses widely, and large amount of the reflected light reach the nozzle surface of the recording head 10. Consequently, the control part 50 operates the shutter driving part 32 of each of the shutter mechanism 30, so as to close the shutter mechanism 30 until the ultraviolet ray irradiating device 20 overlaps with the recording region, open the shutter mechanism 30 provided to the ultraviolet ray irradiating device 20 when the ultraviolet ray irradiating device 20 partially overlaps with the recording region, and close the shutter mechanism 30 provided to the ultraviolet ray irradiating device 20 when the ultraviolet ray irradiating device 20 entirely passes over the recording region. Thus, opening and closing of the shutter mechanism 30 is controlled by changing angle of the shutter plate 33.

Next, recording method by the ink jet recording apparatus 1 according to the present embodiment is described.

First of all, when thickness of the recording medium 4 is inputted from the input part 51 or the like, this information is sent to the control part 50. The control part 50 raises or lowers the carriage 7 by operating the gap adjusting mechanism 52 according to the sent information, and adjusts so that the distance between the platen 5 and the recording head 10 is appropriate for the recording medium 4 to pass and for recording operation.

When the distance between the platen 5 and the recording head 10 is adjusted and image recording operation is started, the control 50 puts on the ultraviolet ray irradiating device 20, and feeds the recording medium 4 in the sub-scanning direction Y. Here, the control part 50 controls the shutter driving part 32 so that the shutter mechanism 30 is closed, until the ultraviolet ray irradiating device 20 overlaps with the recording region.

The position at which the recording medium 4 is placed, is detected by the width detecting sensor 45, and the detection result is sent to the control part 50. The control part 50 constantly determines whether the ultraviolet ray irradiating device 20 is located in the recording region in which the recording medium 4 is placed, according to the detection result of the width detecting sensor 45. When it is determined that the ultraviolet ray irradiating device 20 has overlapped with the recording region, the control part 50 opens the shutter mechanism 30 by operating the shutter driving part 32 of the ultraviolet ray irradiating device 20 that has overlapped with the recording region. When it is determined that the ultraviolet ray irradiating device 20 has deviated from the recording region, the control part 50 closes the shutter mechanism 30 by operating the shutter driving part 32 of the ultraviolet ray irradiating device 20 that has deviated from the recording region, thus ultraviolet ray from the ultraviolet ray irradiating device 20 is shielded. Further, when it is determined that the ultraviolet ray irradiating device 20, that has once deviated from the recording region, moved into the recording region again, the control part 50 opens the shutter mechanism 30 by operating the shutter driving part 32 of the ultraviolet ray irradiating device 20.

The control part 50 makes the recording head 10 jet ink appropriately within reciprocally moving the carriage 7 in the main scanning direction X. Then, by controlling the ultraviolet ray irradiating device 20 with the control part 50, ultraviolet ray is irradiated from the ultraviolet ray irradiating device 20 to the ink jetted on the recording medium 4, thus image is recorded sequentially on the recording medium 4.

As described above, in the present embodiment, since the region in which the recording medium 4 is positioned is defined as the recording region and ultraviolet ray irradiated from the ultraviolet ray irradiating device 20 is shielded in the region other than the recording region, the light quantity of the ultraviolet ray irradiated can be suppressed to required limit. Therefore, the amount of ultraviolet ray that rounds into the nozzle surface of the recording head 10 or the like by being reflected at the recording medium 4 and the platen 5 can be suppressed to a light quantity to an extent so that ink adhered to the nozzle surface of the recording head 10 or the like is not cured. As a result, jetting defect and the like due to curing of the ink adhered to the recording head 10 by the reflected light, can be prevented.

In addition, amount of light that reaches the nozzle surface of the recording head 10 by being reflected at the recording medium 4 and the platen 5 increases in accordance with the increase in distance between the ultraviolet ray irradiating device 20, and the recording medium 4 or the platen 5. Therefore, especially in a case where image recording is conducted using a thick recording medium 4, the distance between the carriage 7 and the platen 5 is adjusted within consideration of the thickness of the recording medium 4, and in a portion where the recording medium 4 is not positioned, the distance between the ultraviolet ray irradiating device 20 provided at a side of the carriage 7 and the platen 5 becomes large. Thus the reflected light may be diffused widely. From this point of view, concerning the present embodiment, since the ultraviolet ray irradiated from the ultraviolet ray irradiating device 20 is shielded in the region other than the region in which the recording medium 4 is positioned, the ultraviolet ray can be prevented appropriately from rounding into the recording head 10 even in a case where the thick recording medium 4 is used.

In addition, since the ultraviolet ray irradiated from the ultraviolet ray irradiating device 20 is shielded by closing the shutter mechanism 30 in the region other than the region in which the recording medium 4 is positioned, the ultraviolet ray irradiating device 20 need not to be turned off. Therefore, especially when using a light source that takes time for start-up when the light source is turned on after it has been turned off once, image recording operation can be conducted efficiently.

Here, in the present embodiment, opening and closing of the shutter mechanism 30 is conducted by rotating the shutter plate 33 within transmitting the movement of the solenoid 40 to the shutter part 31, by providing the solenoid 40 to the shutter driving part 32. However, mechanism to open and close the shutter mechanism 30 is not limited to this mechanism. For example, a small driving source such as a pulse motor and the like may be provided to the shutter driving part 32 to rotate the shutter plate 33.

In the present embodiment, a case in which a plurality of width detecting sensors are provided on a platen has been described. However, it is not limited to the one given here as an example, as long as the width detecting sensor can detect the position of the recording medium 4. For example, it may have a structure in which the width detecting sensor 9 is provided to the carriage 7 or the like, so that the detecting surface of the sensor face the recording surface of the recording medium 4, and the position of the recording medium 4 positioned on the platen 5 is detected in accordance with the movement of the carriage 7. In this case, CCD sensor that includes Charge Coupled Device (CCD) as charge coupled element or the like is applied as the width detecting sensor.

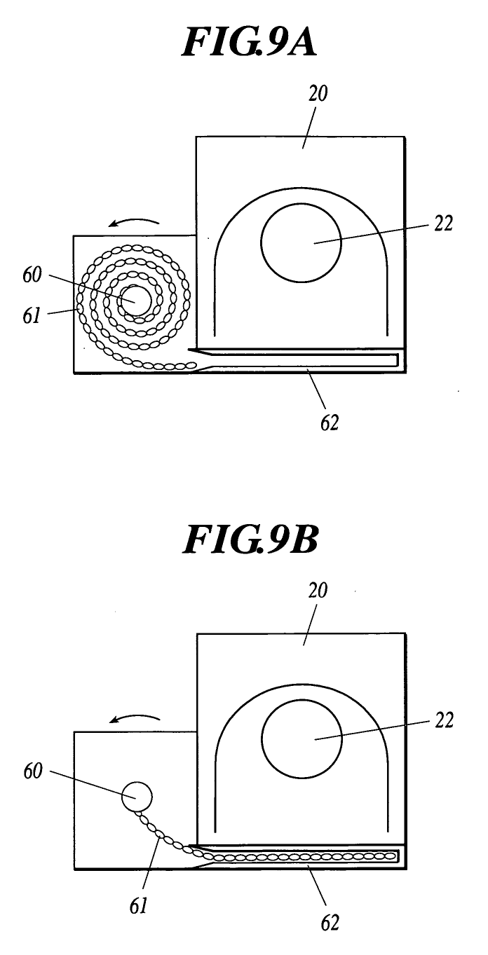

In the present embodiment, a case in which the ultraviolet ray from the ultraviolet ray irradiating device 20 is shielded by using the shutter plate 33 that is capable to change angle, has been described. However, the light shielding mechanism of the ultraviolet ray is not limited to the one given here as example. For example, as shown in FIG. 9A and FIG. 9B, it may have a structure in which a light shielding member 61 that is winded to a rotating axis 60 that is arranged at a side of the ultraviolet ray irradiating device 20, as well as a guide rail 62 to guide the light shielding member 61, is provided to an opening of the ultraviolet ray irradiating device 20 that face the recording medium. In this case, when the ultraviolet ray irradiating device 20 deviates the recording region, the light shielding member 61 is fed along the guide rail 62 by rotating the rotating axis 60, and the ultraviolet ray is shielded by covering the opening of the ultraviolet ray irradiating device with the light shielding member 61.

In the present embodiment, the angle of all the shutter plates 33 are changed by the operation of the shutter driving part 32. However, angle of each shutter plate 33 may be changed independently, or the shutter plate 33 may be divided into several groups and angle may be changed for each group. Thus, shutter mechanism 30 will be in a shielded state partially, so as to suppress the amount of ultraviolet ray that rounds into the nozzle surface of the recording head 10, and light quantity may be suppressed to an extent so that ink adhered to the nozzle surface and the like of the recording head 10 is not cured. Here, as for the light quantity that does not cure the ultraviolet ray curing ink of cationic polymerization type, it is preferable that the amount of ultraviolet ray irradiated per one hour is within 1 m/cm² or less, as afore-described.

In the present embodiment, a structure in which image recording is conducted in a manner which is so called bi-directional printing, that jets ink when the recording head 10 is moved in either direction of the main scanning direction X, has been described. However, it may be also applied to a structure in which image recording is conducted in a manner which is so called one-directional printing, that jets ink only when the recording head 10 moves in either one of the directions. In this case, it is controlled so that the shutter mechanism 30 is opened only when the recording head 10 moves in the direction in which image recording is conducted, and the ultraviolet ray irradiating device 20 is located in the recording region. At other times, the shutter mechanism 30 is closed. Therefore, light quantity of the irradiated ultraviolet ray can be suppressed to the required limit, and the amount of ultraviolet ray that rounds into the nozzle surface of the recording head 10 can be suppressed to an extent so that ink adhered to the nozzle surface or the like of the recording head 10 is not cured.

In the present embodiment, region in which the recording medium 4 is located is determined as the recording region, however, recording width of the image to be recorded on the recording medium 4 may be determined as the recording region.

In this case, the control part 50 serves as a recording region detecting section. For example, according to an image data relating to the recording image sent form an external device such as a personal computer and the like, width of the image to be recorded on the recording medium by image recording operation is detected, and the width of the image to be recorded is determined as the recording region. Here, since the ultraviolet ray irradiated from the ultraviolet ray irradiating device 20 is shielded in a region that exceeds the width of the image to be recorded, light quantity of the irradiated ultraviolet ray can be suppressed to a required limit. Therefore, light that enters the recording head 10 by being reflected at the recording medium 4 or the platen 5 can be suppressed, thus jetting defect or the like, due to the ink adhered to the recording head being cured by reflected light, can be prevented.

In the present embodiment, the ink jet recording apparatus 1 applied with the recording head 10 according to the present invention is a serial head type that forms image, by reciprocally moving the recording head 10 provided to the carriage 7 in the main scanning direction X, as well as jetting ink from the recording head 10 within feeding the recording medium 4 in the sub-scanning direction Y. However, it can be also applied to an ink jet recording apparatus of line head type that forms image, by jetting ink from a recording head that is fixed to the printer body as well as feeding the recording medium.

In the present embodiment, an ink that is cured by irradiating ultraviolet ray was used to conduct image recording. However, the ink is not limited to the one mentioned, and it may be an ink that is cured by irradiating light other than the ultraviolet ray, such as electromagnetic waves including electron ray, X-ray, visible ray, infrared ray, and the like for example. In this case, a polymerizing compound that is polymerized by light other than ultraviolet ray, and a photochemical initiator to initiate polymerization reaction of the polymerizing compound by light other than ultraviolet ray, are applied to the ink. In addition, when an ink that is cured by light other than ultraviolet ray is used, a light source that irradiates the light is applied in place of the ultraviolet ray source.

In addition, the present invention can of course be modified arbitrarily without the limitation of the present embodiment.

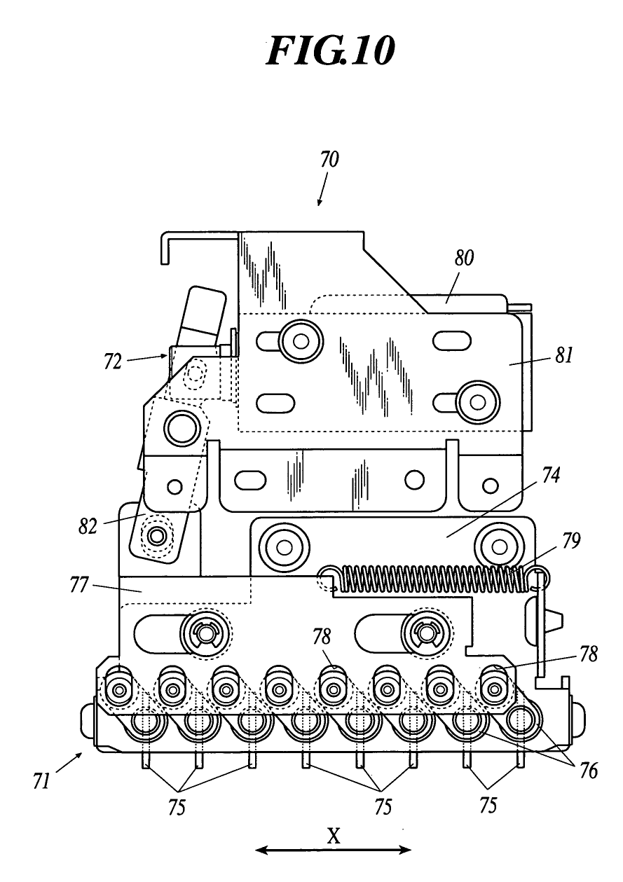

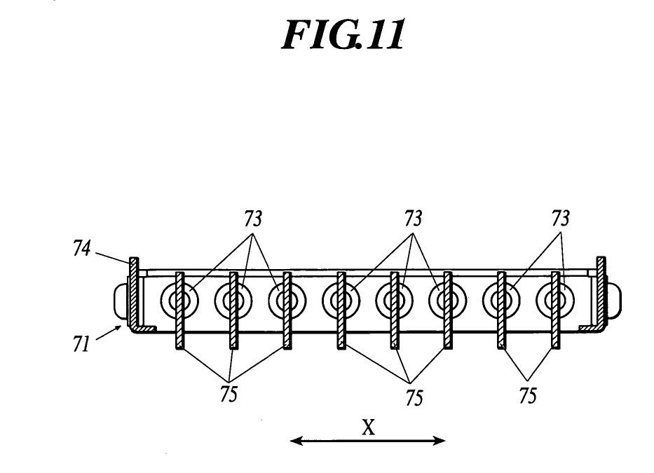

Next, second embodiment of the ink jet recording apparatus according to the present invention is described with reference to FIGS. 10 and 11. Here, the second embodiment has a structure to suppress the amount of the ultraviolet ray, that is irradiated from the ultraviolet ray irradiating device and rounds into the nozzle surface of the recording head, to a light quantity within an extent that curing of ink adhered to the nozzle surface or the like of the recording head does not occur, which is different from that of the first embodiment. Therefore, description will be made particularly concerning the points that differ from the first embodiment.

The ink jet recording apparatus of the present embodiment is, in a similar manner as the first embodiment, an ink jet recording apparatus of serial head type. To both ends of a carriage, an ultraviolet ray irradiating device is provided to irradiate ultraviolet ray (both of them not shown). On a platen that supports the recording medium, a width detecting sensor (not shown) to detect the position of the recording medium is provided in a similar manner as the first embodiment. The ink jet recording apparatus is provided with a control part (not shown) in a similar manner as the first embodiment, and the control part determines the width, in which the recording medium detected by the width detecting sensor is positioned, as a recording region.

The ultraviolet ray irradiating device is provided with a cover member (not shown) to cover an ultraviolet ray source in a similar manner as the first embodiment. To the cover member, light guiding mechanism 70 to suppress the amount of the ultraviolet ray that rounds into the nozzle surface of the recording head, to an extent so that ink adhered to the nozzle surface or the like of the recording head is not cured, is provided. This is achieved by guiding the light irradiated from the ultraviolet ray irradiating device, to change the direction in which the light is irradiated.

As shown in FIGS. 10 and 11, the light guiding mechanism 70 is structured with a light guiding part 71 to guide the light irradiated from the ultraviolet ray irradiating device by covering an opening of a cover member (not shown), and a guiding mechanism driving part 72 to operate the light guiding part 71.

To the light guiding part 71, a plurality of light guiding members 75 to guide the irradiated light in a predetermined direction, that have approximately the same length as that of the opening of the cover member in the sub-scanning direction which is orthogonal to the main scanning direction X, and a guiding member supporting member 74 to support the light guiding member 75. The guiding member supporting member 74 is a frame body that is formed with substantially the same area as that of the opening of the cover member, and is attached to the opening of the cover member with a screw or the like (not shown).

To both sides of the guiding member supporting member 74 in the sub-scanning direction, a supporting member 73 to support the light guiding member 75 is provided in the number that corresponds to that of the light guiding member 75. Both ends of the light guiding member 75 are supported by the supporting member 73, thus it is supported by the guiding member supporting member 74 rotatably, regarding the main scanning direction that is orthogonal to the sub-scanning direction.

As shown in FIG. 10, to the supporting member 73 provided to one end side of the guiding member supporting member 74, arm-shaped member 76 that can each oscillate is attached, and the supporting member 73 rotate in the main scanning direction X according to the oscillation of the arm-shaped member 76. An end of the arm-shaped member 76 are each seized to a seizing pore 78 formed to a oscillating member 77 that oscillates according to the operation of the guiding mechanism driving part 72. In the present embodiment, when the oscillating member 77 oscillates from the right side to the left side in the main scanning direction X as shown in FIGS. 10 and 11, the supporting member 73 rotates in a direction so that the light guiding member 75 is orthogonal to the recording medium. In contrast, when the oscillating member 77 oscillates from the left side to the right side in the main scanning direction X as shown in FIGS. 10 and 11, the supporting member 73 rotates in a direction so that the light guiding member 75 is inclined to the recording medium. In addition, the oscillating member 77 is seized to the guiding member supporting member 74 by a spring 79, thus the oscillating member 77 is powered in a direction in which the light guiding member 75 is inclined to the recording medium.

The guiding mechanism driving part 72 is, for example, provided with a solenoid 80 that conducts reciprocal movement along the main scanning direction X by application of current, and a driving part supporting member 81 to support the solenoid 80. To the solenoid 80, a transmission arm 82 that has its one end seized to the oscillating member 77 is attached, and the reciprocal movement of the solenoid 80 is transmitted to the oscillating member 77 through the transmission arm 82.

Here, since other structures are the same as the first embodiment, the same symbol is cited for the same structure, and its description is omitted.

Next, recording method of the ink jet recording apparatus according to the present embodiment is described.

First of all, the carriage is raised or lowered according to the. thickness of the recording medium, so that the distance between the platen and the recording head is appropriate for the recording medium to pass and for recording operation.

When the distance between the platen and the recording head is adjusted and image recording operation is started and the image recording operation is conducted, the position at which the recording medium is placed, is detected by the width detecting sensor, and the detection result is sent to the control part. The control part constantly determines whether the ultraviolet ray irradiating device is located in the recording region in which the recording medium is placed, according to the detection result of the width detecting sensor.

When it is determined that the ultraviolet ray irradiating device is located in the recording region in which the recording medium is placed, the control part changes the angle of the light guiding member 75 so that the light guiding member 75 is inclined to the recording medium, by operating the guiding mechanism driving part 72 of the light guiding mechanism 70, that is provided to the ultraviolet ray irradiating device and has deviated the recording region. Thus, the light irradiated from the ultraviolet ray irradiating device is guided so that the light which rounds into the nozzle surface or the like of the recording head by being reflected at the recording medium or the plate is suppressed.

As described, in the present embodiment, the region in which the recording medium is placed is defined as the recording region. In a region other than the recording region, the angle of the light guiding member 75 is changed to guide the light irradiated from the ultraviolet ray irradiating device, so that the light that rounds into the nozzle surface or the like of the recording head by being reflected at the recording medium or the platen is suppressed. Therefore, light that enters the recording head by being reflected at the recording medium or the platen can be suppressed, and jetting defect and the like due to the ink adhered to the recording head being cured by the reflected light can be prevented.

Here, in a similar manner as the first embodiment, the present invention is not limited to the present embodiment.

Next, a third embodiment of the ink jet recording apparatus according to the present invention is described. Here, in the third embodiment, since only the controlling structure to control the shutter mechanism 30 of the ultraviolet ray irradiating device is different from the first embodiment and the second embodiment, description will be made particularly concerning the points that differ from the first and the second embodiment.

The ink jet recording apparatus of the present embodiment is, in a similar manner as the first embodiment and the second embodiment, an ink jet recording apparatus of serial head type. An ultraviolet ray irradiating device to irradiate ultraviolet ray is provided to both sides of the carriage. To the ultraviolet ray irradiating device, a shutter mechanism similar to that of the first embodiment is provided. In addition, on the platen to support the recording medium, a width detecting sensor to detect the position of the recording medium is provided in a similar manner as the first embodiment.

The ink jet recording apparatus is provided with a control part similar to that of the first embodiment, and detection result of the width detecting sensor is sent to the control part. The control part determines the width in which the recording medium is positioned, which is detected by the width detecting sensor, as the recording region.

In addition, the ink jet recording apparatus is capable to adjust the height of the platen according to the thickness of the platen or the like, and information concerning the height of the platen is stored in RAM or the like of the control part.

In the present embodiment, according to the information concerning the height of the platen, the control part determines whether to conduct or not the control to shield the ultraviolet ray irradiated from the ultraviolet ray irradiating device, by closing the shutter mechanism of the ultraviolet ray irradiating device, in a region other than the recording region. That is, in a case where light irradiated from the ultraviolet ray irradiating device is reflected at the recording medium or the platen, the reflected light diffuses, in correspondence to the increase in distance between the ultraviolet ray irradiating device, and the recording medium or the platen. Thus, the possibility that the reflected light may reach the nozzle surface of the recording head increases. Further, since the height of the platen is adjusted according to the thickness of the recording medium, in a case where the thickness of the recording medium is large, the distance between the ultraviolet ray irradiating device and the platen becomes large in the portion where the recording medium is not positioned. Therefore, for example, in a case where the height of the platen is set higher than the predetermined threshold value, the control part conducts control to shield the ultraviolet ray irradiated from the ultraviolet ray irradiating device, by closing the shutter mechanism of the ultraviolet ray irradiating device in the region other than the recording region in which the recording medium is positioned.

Here, since the other structures are the same as those of the first embodiment, the same symbols are cited for the same structure, and its description is omitted.

Next, recording method of the ink jet recording apparatus according to the present embodiment is described.

First of all, the platen is raised or lowered according to the thickness of the recording medium, so that the distance between the platen and the recording head is appropriate for the recording medium to pass and for recording operation.

When the distance between the platen and the recording head is adjusted and image recording operation is started, the position at which the recording medium is placed is detected by the width detecting sensor, and the detection result is sent to the control part. The control part constantly determines whether the ultraviolet ray irradiating device is located in the recording region in which the recording medium is placed, according to the detection result of the width detecting sensor. Further, the control part refers to the information on the height of the platen, to what extent the height of the platen is set. Then, it is determined whether or not to shield the ultraviolet ray irradiated from the ultraviolet ray irradiating device by closing the shutter mechanism when the ultraviolet ray irradiating device deviates the recording region.

In a case where the height of the platen is set higher than the predetermined threshold value, the control part closes the shutter mechanism of the ultraviolet ray irradiating device that deviated the recording region, and shields the ultraviolet ray irradiated from the ultraviolet ray irradiating device. Further, in a case where it is determined that the ultraviolet ray irradiating device that has once deviated from the recording region has moved to the recording region again, the control part operates the shutter driving part of the shutter mechanism concerning the ultraviolet ray irradiating device, to open the shutter mechanism.

As described, in the present embodiment, the region in which the recording medium is positioned is defined as the recording region, as well as it is determined with respect to the height of the platen, whether or not to shield the ultraviolet ray irradiated from the ultraviolet ray irradiating device, in the region other than the recording region. Therefore, light quantity of irradiated ultraviolet ray can be suppressed to required limit by operating the shutter mechanism effectively. Thus, light that enters the recording head by being reflected at the recording medium or the platen can be suppressed, and jetting defect and the like due to the ink adhered to the recording head being cured by the reflected light can be prevented.

Here, in the present embodiment, height of the platen is adjustable, and determination on whether or not to conduct control to close the shutter mechanism of the ultraviolet ray irradiating device in the region other than the recording region is made according to the information on the height of the platen. However, as shown in the first embodiment for example, distance between the carriage and the platen may be adjusted by raising and lowering the carriage. In this case, it is structured so that information on the distance between the carriage and the platen is sent to the control part, and the control part determines whether or not to conduct control to close the shutter mechanism of the ultraviolet ray irradiating device in the region other than the recording region.

In addition, in the present embodiment, determination on whether or not to shield the ultraviolet ray irradiated from the ultraviolet ray irradiating device in the region other than the recording region was made according to whether the height of the platen is larger than the predetermined threshold value or not. However, criterion with which it is determined whether or not to shield the ultraviolet ray irradiated from the ultraviolet ray irradiating device in the region other than the recording region, is not limited to the given example. For example, the determination may be made according to the type of the recording medium used for the image recording.

That is, in a case where a thick recording medium is used as the recording medium, distance between the ultraviolet ray irradiating device and the recording medium is narrow in the portion where the recording medium is positioned, and thus the light reflected at the recording medium is not diffused widely. However, in the portion where the recording medium is not positioned, since the distance between the ultraviolet ray irradiating device and the platen is wide, the light reflected at the platen diffuse and reach the nozzle surface of the recording head, thus cures the ink and becomes a cause for jetting defect. Therefore, in a case where the thickness of the recording medium is larger than the predetermined threshold value, it may be controlled so as to shield the ultraviolet ray irradiated from the ultraviolet ray irradiating device in the region other than the recording region.

Here, in a similar manner as the first embodiment and the second embodiment, the present invention is not limited to the present embodiment.

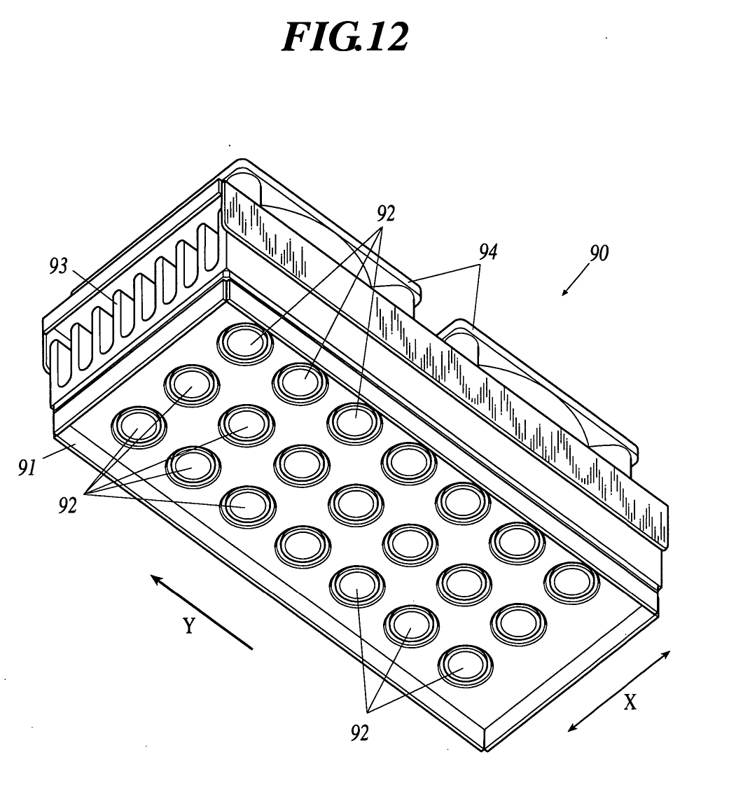

Next, with reference to FIG. 12, a fourth embodiment of the ink jet recording apparatus according to the present invention will be described. Here, the fourth embodiment is different from the first through the third embodiments, in terms of type of light source provided to the ultraviolet ray irradiating device 90, and in terms of the structure to suppress light quantity of the ultraviolet ray that is irradiated from the ultraviolet ray irradiating device 90 and rounds into the nozzle surface of the recording head, to an extent so that ink adhered to the nozzle surface or the like of the recording head is not cured. Hereinafter, description will be made particularly concerning the points that differ from the first through the third embodiments.

The ink jet recording apparatus of the present embodiment is, in a similar manner as the first through the third embodiments, an ink jet recording apparatus of serial head type. To both ends of a carriage (not shown), an ultraviolet ray irradiating device 90 is provided to irradiate ultraviolet ray. On a platen (not shown) that supports the recording medium, a width detecting sensor (not shown) to detect the position of the recording medium is provided in a similar manner as. the first through the third embodiments. The ink jet recording apparatus is provided with a control part (not shown) in a similar manner as the first through the third embodiment, and the control part determines the width, in which the recording medium detected by the width detecting sensor is positioned, as a recording region.

The ultraviolet ray irradiating device is provided with a cover member 91 that has an opening towards the recoding medium, to cover the ultraviolet ray source, in a similar manner as the first through the third embodiments. At the inner side of the opening of the cover member 91, a plurality of Light Emitting Diodes (LED) 92 as the ultraviolet ray source are arranged in a row, along the sub-scanning direction Y. Here, in FIG. 12, LED 92 are arranged in a plurality of rows along the main scanning direction X, however, arrangement of LED is not limited to the example given in figure, and it may have a structure in which one row of LED is arranged along the sub-scanning direction Y, for example.

In the present embodiment, the control part turns on the LED which is the ultraviolet ray source, when it is determined that the ultraviolet ray irradiating device 90 is positioned in the recording region, according to the detection result detected by the width detecting sensor. When it is determined that the ultraviolet ray irradiating device 90 is in the region other than the recording region, the ultraviolet ray irradiating device 90 is controlled so as to turn off the LED. Therefore, light quantity of ultraviolet ray that is irradiated from the ultraviolet ray irradiating device 90 and rounds into the recording head side, is suppressed to an extent so that it does not cure ink.

As shown in FIG. 12, to a surface that is opposite to the side where opening of the cover member 91 is provided, a heat sink 93 to dissipate heat generated from the light source is provided. In addition, to a surface of the heat sink 93 which is at the opposite side that contacts the cover member, a cooling fan 94 to further externally release heat that was dissipated by the head sink 93, is provided. Here, the ultraviolet ray irradiating device is suffice as long as it is provided with a structure that can release heat generated from the light source to external. Therefore, structure to release heat generated from the ultraviolet ray irradiating device is not limited to the example given in figure. For example, it may be a structure in which either one of the heat sink 93 or the cooling fan 94 is provided to the surface that is opposite to the side where opening of the cover member 91 is provided, or a mechanism to dissipate heat by circulating liquid such as a water cooling mechanism or the like, a cooling mechanism that uses peltiert element, or the like may be used in place of the heat sink 93 or the cooling fan 94.

Here, since other structures are the same as the first embodiment through the third embodiment, the same symbol is cited for the same structure, and its description is omitted.

Next, recording method of the ink jet recording apparatus according to the present embodiment is described.

First of all, the carriage is raised or lowered according to the thickness of the recording medium, so that the distance between the platen and the recording head is appropriate for the recording medium to pass and for recording operation.

When the distance between the platen and the recording head is adjusted and image recording operation is started, the control part feeds the recording medium in the sub-scanning direction Y, as well as reciprocally moves the carriage in the main scanning direction X within jetting ink suitably from the recording head. At this time, the control part constantly determines whether or not the ultraviolet ray irradiating device 90 is positioned in the recording region, and the LED 92 as the light source is turned off until the ultraviolet ray irradiating device 90 overlaps with the recording region. Then, when it is determined that the ultraviolet ray irradiating device 90 has overlapped with the recording region, the control part turns on the LED 92 of the ultraviolet ray irradiating device 90 that has overlapped with the recording region. When it is determined that the ultraviolet ray irradiating device 90 has deviated the recording region, the control part turns off the LED 92 of the ultraviolet ray irradiating device 90 that has deviated the recording region. Here, heat generated by turning on the LED 92 is released to external by the heat sink 93 and the cooling fan 94.

Subsequently, ultraviolet ray is irradiated from the ultraviolet ray irradiating device 90 to the ink jetted on the recording medium 4, thus image is recorded on the recording medium sequentially.

As described, in the present embodiment, the region in which the recording medium is positioned is defined as the recording region, and ultraviolet ray that rounds into the nozzle surface or the like of the recording head by being reflected at the recording medium or the platen is suppressed, by turning off the LED 92 as the light source in the region other than the recording region. Therefore, light that enters the recording head by being reflected at the recording medium or the platen can be suppressed, and jetting defect or the like due to the ink adhered to the recording head being cured, can be prevented.

In addition, according to the present embodiment, light quantity of ultraviolet ray that is irradiated from the ultraviolet ray irradiating device 90 and rounds into the recording head side can be suppressed without providing a particular mechanism such as the shutter mechanism, the light guiding mechanism, or the like. Therefore, structure of apparatus can be simplified, thus the apparatus can be lightened and cost can be suppressed by decreasing the number of parts.

In the present embodiment, LED 92 was provided as the light source of the ultraviolet ray irradiating device 90, however, light source is not limited to the given example. For example, a low pressure mercury lamp or the like as described in the first embodiment can be applied.

In the present embodiment, amount of the ultraviolet ray that is irradiated from the ultraviolet ray irradiating device 90 and rounds into the nozzle surface of the recording head, is suppressed to an extent so that ink that adhered to the nozzle surface or the like of the recording head is not cured, by turning on and off the LED arbitrarily. However, structure to suppress the light quantity is not limited to the given example. For example, amount of the ultraviolet ray that is irradiated from the ultraviolet ray irradiating device 90 and rounds into the nozzle surface of the recording head, may be suppressed to an extent so that ink that adhered to the nozzle surface or the like of the recording head is not cured, by turning on only a part of LED 92, thus turning off only the LED 92 in the portion that deviated the recording region.

Further, in a case where a light source that is capable to adjust light quantity by the supplied electrical energy or the like, light quantity may be suppressed by conducting control to suppress electricity supplied to the ultraviolet ray irradiating device.

Here, in a similar manner as the first embodiment through the third embodiment, the present invention is not limited to the present embodiment.

This application is based upon and claims the benefit of priority from prior Japanese Patent Application No. 2005-284814, filed on Sep. 29, 2005, and the entire contents including specification, claims, figures, and drawings, are incorporated herein by reference.

What is claimed is:

1. An ink jet recording apparatus comprising:
a recording head to jet a photo-curable ink, that is cured by irradiating light, on a recording medium;
a light irradiating device to irradiate light to a jetted ink jetted from the recording head;
a recording region detecting section to detect a recording region; and
a control part to control light quantity irradiated from the light irradiating device so that amount of light which is irradiated from the light irradiating device and rounds into the recording head side is suppressed to an extent so that the photo-curable ink is not cured, in a region other than the recording region detected by the recording region detecting section.

2. The ink jet recording apparatus of claim 1, wherein the recording region detected by the recording region detecting section is a region in which the recording medium is positioned.

3. The ink jet recording apparatus of claim 1, wherein the recording region detected by the recording region detecting section is a recording width of an image that is to be recorded on the recording medium.

4. The ink jet recording apparatus of claim 1, further comprising:
a light shielding mechanism that is capable to shield light irradiated by the light irradiating device entirely or partially, wherein the control part controls the light shielding mechanism so that the amount of light which is irradiated from the light irradiating device and rounds into the recording head side is suppressed to an extent so that the photo-curable ink is not cured, in the region other than the recording region detected by the recording region detecting section.

5. The ink jet recording apparatus of claim 1, further comprising:
a light guiding mechanism that is capable to guide light irradiated by the light irradiating device entirely or partially; wherein the control part controls the light guiding mechanism so that amount of light which is irradiated from the light irradiating device and rounds into the recording head side is suppressed to an extent so that the photo-curable ink is not cured, in the region other than the recording region detected by the recording region detecting section.

6. The ink jet recording apparatus of claim 1, wherein the control part controls the light irradiating device so as to turn off the light irradiating device in the region other than the recording region detected by the recording region detecting section.

7. The ink jet recording apparatus of claim 1, further comprising:
a recording medium supporting member to support the recording medium, wherein the control part determines whether or not to conduct control so that the amount of light which is irradiated from the light irradiating device and rounds into the recording head side is suppressed to an extent so that the photo-curable ink is not cured, according to distance between a surface of the recording head that face the recording medium and the recording medium supporting member.

8. The ink jet recording apparatus of claim 1, wherein the control part determines whether or not to conduct control so that the amount of light which is irradiated from the light irradiating device and rounds into the recording head side is suppressed to an extent so that the photo-curable ink is not cured, according to thickness of the recording medium.

9. The ink jet recording apparatus of claim 1, wherein the recording head is a serial print type that jets the photo-curable ink on the recording medium within moving in a direction that is orthogonal to a feeding direction of the recording medium.

10. The ink jet recording apparatus of claim 9, wherein:
the light irradiating device comprises an upstream light irradiating device and a downstream light irradiating device that are arranged at upstream side and downstream side regarding a moving direction of the recording head respectively; and
the control part controls the amount of light which is irradiated from the light irradiating device and rounds into the recording head side, independently with the upstream light irradiating device and the downstream light irradiating device.

11. The ink jet recording apparatus of claim 1, wherein:
the recording head moves reciprocally;
the control part conducts control so that the photo-curable ink is jetted from the recording head only when the recording head moves in one of either directions; and
the control part conducts control according to movement of the recording head, so that the amount of light which is irradiated from the light irradiating device and rounds into the recording head side is suppressed.

12. The ink jet recording apparatus of claim 1, wherein the photo-curable ink is an ultraviolet ray curing ink that is cured by irradiating ultraviolet ray, and at least part of the light irradiated from the light irradiating device is ultraviolet ray.

13. The ink jet recording apparatus of claim 1, wherein the photo-curable ink is a cationic polymerization type ink including a cationic polymerizing compound.

14. A recording method comprising:
a jetting step to jet a photo-curable ink, that is cured by irradiating light, from a recording head to a recording medium;
a light irradiating step to irradiate light from a light irradiating device to a jetted ink jetted from the recording head;
a detecting step to detect a recording region; and
a suppressing step to suppress amount of light which is irradiated from the light irradiating device and rounds into the recording head side to an extent so that the photo-curable ink is not cured, in a region other than the recording region, according to detection result.
